(19) United States
(12) Patent Application Publication
(10) Pub. No.: US 2016/0009391 A1
(43) Pub. Date: Jan. 14, 2016

(54) Stable Low Aspect Ratio Flying Wing

(71) Applicant: Eric Walter Friesel, Warrensburg, MO (US)

(72) Inventor: Eric Walter Friesel, Warrensburg, MO (US)

(21) Appl. No.: 14/070,586

(22) Filed: Nov. 4, 2013

(51) Int. Cl. B64C 39/10; B64C 21/06; B64C 25/34; B64C 5/10; B64C 1/00

(52) U.S. Cl. CPC B64C 39/10; B64C 5/10; B64C 1/0009; B64C 25/34; B64C 21/06; B64C 2001/0045

(57) ABSTRACT

A low aspect ratio flying wing provides aerodynamic stability throughout the flight envelope with improved aerodynamic efficiency. Insufficient stability and reduced aerodynamic efficiency typical of low aspect ratio flying wings is improved through wing design and proper application and placement of horizontal stabilizers and boundary layer control. Lateral asymmetric boundary layer manipulation is employed to alter flying wing orientation in flight. Lateral extension and retraction of the main structure wing optimizes efficiency. This novel flying wing is not found in literature or “prior art” and provides improvement in aerodynamic stability and efficiency over previous designs. Given the large amount of research, literature, patents and activity in the field since the 1930's and the absence of a practical design indicates the non-obvious nature of these disclosures. In addition, those skilled in the art teach away from present disclosures failing to realize the better than predicted advantages.

### TECHNICAL FIELD

### Field of the Invention

This application takes advantage of the filing date of application Ser. No. 13/674,911, filed 12 Nov. 2012. This application takes advantage of filing date of the ornamental design application 29/437,045, filed 12 Nov. 2012. The field of this invention is a stable, aerodynamically efficient, low aspect ratio flying wing aircraft teaching wing character, tail configuration and boundary layer control.

### BACKGROUND ART

### Background of the Invention

Flying wing aircraft have been proposed for over 80 years with very few successful commercial and military embodiments; reference a well written historical description on flying wings in U.S. Pat. No. 6,923,403 (PTL 24). This longstanding pursuit for viable advantageous flying wing designs is testament to the non-obvious nature of the field. While many assume aerodynamics is a completely characterized technical field, citing deterministic analytical computational fluid dynamics (CFD) simulation tools, the reality is something less certain. Wind tunnel and flight testing remain important aspects of new aircraft design for this reason. Test data is used to correct and validate CFD models. Combining low aspect ratio with the already complex flying wing design presents additional challenges forming significant subsections of the flying wing design “prior art” effort dating back to at least 1931.

Two primary challenges of low aspect ratio flying wing designs are aerodynamic stability and aerodynamic efficiency. The first challenge of flying wing stability has been effectively overcome in “prior art” with complex and costly active computerized dynamic flight controls. Static control designs in low aspect ratio “prior art” without expensive active systems have been largely abandoned due to unpredictable and sometimes dangerous instability documented in recurring NASA lifting body research and other NASA reports (i.e. NPL 2). Current state-of-the-art flying wing designs in use rely on expensive active controls that are justified to achieve other performance objectives in very specialized applications. In addition to stability problems, low aspect ratio designs, with short wingspan relative to chord length, have a reduced aerodynamic efficiency. Decreased aerodynamic efficiency reduces airspeed, payload and range. As aircraft aerodynamic efficiency decreases fuel efficiency decreases yielding increased life-cycle costs for operation. Reducing cost by eliminating active control requirements and improving aerodynamic efficiency and stability in low aspect ratio flying wing has immediate application in industry.

Understanding aerodynamic stability of a low aspect ratio flying wing design is complicated by unpredictable dynamic forces on control surfaces in the longitudinally aft regions due to uncharacterized airflow disruptions downstream of the primary airfoil. While lifting body airfoil design shapes are significantly different from flying wing airfoil designs the uncharacterized low aspect ratio stability problems apply. Banks and Fischer reported on NASA X-24B free flight lifting body tests in 2006 concluding that lateral-directional (roll) instability similar to that observed in NASA heavy lifting body flight tests in the 1960's were unpredictable and no conclusive cause determined. Horizontal stabilizers were used on the NASA M2-F1 lifting body but were removed on subsequent designs due to physical stresses expected during the NASA intended operational environment of space reentry (NPL 2). NASA studied lifting bodies primarily for use as reentry vehicles and space “lifeboats” small enough to fit within a space launch vehicle.

A common control surface observed in “prior art” are “v-tails” extending laterally outward ascending or descending vertically away from the longitudinal axis from the rear lateral extents of the primary body. This design was used on the NASA HL-10 lifting body (NPL 2). Other examples of this design can be seen in U.S. Pat. No. 3,536,278 (PTL 11), U.S. Pat. No. 4,151,893 Wing in Ground Effect (PTL 17), U.S. Pat. No. D396,685 (PTL 15); vertically descending “v-tail” U.S. Pat. No. 4,149,688 (PTL 16). The “v-tail” design is effective for stability but presents high frequency rolling motions side to side known as a “dutch roll” in turbulence that is naturally perceived by pilots as instability. Low aspect ratio lifting bodies and flying wings have a large “dihedral effect” meaning that sideslip such as that encountered during a “dutch roll” induces a roll. This tendency was experienced by test pilot Bruce Peterson on May 10^{th}, 1967 and was assessed as a contributing factor to the M2-F2 lifting body crash featured during the introduction of the U.S. television show “Six Million Dollar Man”. While at altitude a sideslip induced during turbulence created large 200 degree high frequency rolling motions. Although the side to side rolling motion was recovered well before the landing impact the apparent instability of the aircraft led to the series of events eventually ending in a crash landing (NPL 2).

Aerodynamic efficiency is a disadvantage of low aspect ratio wings. This has been characterized in the Lanchester-Prandtl theory (NPL 4). Because of low aspect ratio decrease in lift and increase in drag at high lift coefficients high aspect ratio wings are favored as the predominant aircraft design with increased aerodynamic efficiency. High altitude aircraft that operate in very thin air require increased lift to maintain level flight. In this operating regime low drag at high lift coefficients are a significant advantage. Because of this long thin wings are optimum for high altitude aircraft. Also induced drag increases inversely with respect to aspect ratio. This is evidenced by low aspect ratio wings slowing more abruptly with fly-up tendency.

Flying wings can be described by several major design factors such as tailed or tailless, low (˜0.5 thru ˜1.5), medium (˜1.5 thru ˜3) or high (greater than ˜3) aspect ratio, and with or without distinct central body (aka fuselage). Typically a vehicle with a conventional round fuselage inconsistent with the shape of the wing is not considered a flying wing. However there is class of aircraft called blended wing body that is a considered a hybrid flying wing with a central body structure of a shape consistent with and contoured to a main structure wing.

Examples of “prior art” related to flying wings are numerous. Several relevant examples date back to 1931 with Charpentier U.S. Pat. No. 1,893,129 (PTL 1) where the center body is a flying wing with vertical stabilizers. Fleming U.S. Pat. No. 2,294,367 (PTL 2) presents a flying wing that is laterally extendable and retractable with vertical and horizontal stabilizers within the lateral extents of the main structure wing. U.S. Pat. No. 2,402,358 (PTL 3) presents a tailless flying wing that uses through passageways from the lower surface to the upper surface for boundary layer control. U.S. Pat. No. 2,561,291 (PTL 4) is a “roadable” aircraft flying wing with a vertical stabilizer along the dorsal center of the vehicle. U.S. Pat. No. 2,681,773 (PTL 6) is a follow on “roadable” aircraft flying wing with horizontal stabilizer within the lateral extents of the main structure wing and sides that fold out laterally to increase wing area. U.S. Pat. No. 2,989,269 (PTL 9) is a tailed flying wing claiming vertical rotors running vertically through the main wing that reposition outside the wing for horizontal thrust and said flying wing with vertical and horizontal stabilizers within the lateral extents of the main wing structure. U.S. Pat. No. 4,440,361 (PTL 19) claiming a rectangular wing of aspect ratio 0.35 to 1 with an air inlet duct on the upper surface between 25 and 40 percent chord length aft of leading edge and said flying wing without vertical or horizontal stabilizers. U.S. Pat. No. 2,734,701 (PTL 7) represents a flying wing body without horizontal stabilizers and including high aspect ratio wing extensions. U.S. Pat. No. 3,083,936 (PTL 10) represents a flying wing with horizontal stabilizers vertically aligned with the wing chord and said flying wing including high aspect ratio wings. U.S. Pat. No. 6,098,922 (PTL 22) claims a flying wing body of low aspect ratio with attached high aspect ratio wings and vertical and horizontal stabilizers within the lateral extents of the main flying wing body. All of these designs either include a high aspect ratio wing or suffer from the low aspect ratio flying wing aerodynamic control and efficiency problems described previously.

Horizontal stabilizers on “prior art” low aspect ratio and flying wing aircraft designs are aligned vertically very closely to the main wing body chord line. Vought XF5U “flying pancake” is a primary example. Teaching vertically offset horizontal stabilizers extending beyond the lateral extents of the wing for efficiency and stability improvement of low aspect ratio flying wings was not found in “prior art”. Similar art and related art was identified in patent and non-patent literature search. The most relevant are now briefly described.

NASA M2-F1, horizontal tail as described was successfully demonstrated on a low aspect ratio lifting body “bathtub” design. Lifting body designs do not utilize conventional wing sections rather a lifting body “bathtub” shape. One aerodynamic difference between these designs is indicated by a center of gravity aft of 50 percent chord on the M2-F1 lifting body. Typical flying wing sections target a center of gravity of 25 percent chord. The M2-F1 main structure wing shape (NPL 2) is a highly swept leading edge “bathtub” shape.

U.S. Pat. No. D223,869 (PTL 13) and U.S. Pat. No. 3,774,864 (PTL 14) discloses a cargo “airplane” design with a medium (>2) aspect ratio, a conventional round fuselage body and a “t-tail” attached to outer bodies.

U.S. Pat. No. 5,860,620 (PTL 20) discloses a wing in ground effect (WIG) design with a main structure of a fuselage body and including a low aspect ratio wing and a ducted propeller forward of the wing leading edge to provide efflux or “ram air” over the wing. This design specifies a fuselage, steerable ducted propeller propulsion unit forward of the wing leading edge and is a design optimized machine for use in ground effect operations. Multiple “v-tail” and “t-tail” configurations are presented as optional configurations.

U.S. Pat. No. 6,325,011 (PTL 23) and U.S. Pat. No. 5,950,559 (PTL 21) discloses air and fluid supported wing in ground effect (WIG) vehicle designs intended for use over water. An air and water fin combination is depicted providing stability from crosswind tripping on the water at high speed. The yaw induced by crosswinds is described to cause counterbalancing forces between the claimed combination of water fins and the air fins. This design hull/wing is of highly swept back leading edge and laterally contoured shape optimized for high speed over water in ground effect.

Boundary layer control using suction and blowing slots has general basis in “prior art” without specific application. As early as 1959 using air flow control for improved lift is found in U.S. Pat. No. 2,886,264 (PTL 8). NASA investigations date back to 1929 (NPL 3). Use of boundary layer airflow modification for control is referenced in U.S. Pat. No. 3,583,600 (PTL 12) disclosing blowing augmentation over trailing edge flaps. Blowing air along the leading edge to disrupt lift for control is presented in U.S. Pat. No. 4,267,990 (PTL 18).

Previous “prior art” described herein was found to have relevance as background information for present disclosures.

### SUMMARY OF INVENTION

### Technical Problem

“Prior art” low aspect ratio flying wings are inherently unstable presenting unpredictable and dangerous flight characteristics in dynamic conditions. Unpredictable dynamic forces on “prior art” tail end control surfaces are largely caused by disrupted airflow from the primary wing and resulting pressure disturbances. These phenomena have been measured and documented by NASA in wind tunnel and flight testing. Low aspect ratio designs also suffer from decreased aerodynamic efficiency as compared to the higher aspect ratio designs of long thin wing conventional aircraft. Because of these issues “prior art” has not yielded practical low aspect ratio flying wing design in 80 years. As a result low aspect ratios less than 2 or 3 are rarely considered in practical aircraft, including flying wing design, by those skilled in the art.

Professionals of the art and common practice teach away from low aspect ratio wing applications at least in part due to these characteristics. In fact, failure of these designs and frequent depiction of low aspect ratio flying wings in science fiction stories has led to a popular sentiment that they are not viable. Current state-of-the-art supports this sentiment as accurate and those professionals skilled in the art teach away from low aspect ratio designs reasoning that they are impractical for use other than potentially in gliding vehicles such as space recovery vehicles, U.S. Pat. No. 3,536,278 (PTL 11), and wing in ground effect vehicles, U.S. Pat. No. 5,860,620 (PTL 20), U.S. Pat. No. 5,950,559 (PTL 21) and U.S. Pat. No. 6,325,011 (PTL 23). Even in these niche roles, where research effort has been applied, actual use has been predominantly relegated to applying lessons learned to more conventional designs such as the delta wing glider design of the space shuttle.

Aerodynamic efficiency challenges of low aspect ratio wings exist. Low coefficient of lift due to low aspect ratio is well known and characterized. Induced drag is significantly greater in low aspect ratio wings particularly at high angles of attack where lift generation is a fraction of a high aspect ratio wing. Finally profile drag of thicker airfoils, typical of the low aspect ratio wing, is much greater than the relatively thinner airfoils of high aspect ratio wings requiring increased thrust to achieve high speeds.

Weight and complexity of suction and blowing slot boundary layer control structures and equipment on long thin wings generally reduces overall design aerodynamic efficiency. Physical size and air pressures required on longer slots of high aspect ratio wings make this form of boundary layer control non-advantageous. Any advantage in lift is overshadowed by the disadvantages of the additional weight required for installation. This leads those skilled in the art to teach away from suction and blowing slot boundary layer controls preferring other lower weight and complexity options such as vortex generators, lower to upper surface slots, etc. . . .

### Solution to Problem

A stable low aspect ratio flying wing is presented that improves aerodynamic efficiency and overcomes several limitations of “prior art”. A main structure of a low aspect ratio wing provides increased wing area. Boundary layer control in the form of suction slots and rearward blowing slots has been shown to improve aerodynamic efficiency. Use of novel tail assembly configuration, boundary layer control and other features as specified and claimed in disclosures yields a more advantageous than predicted low aspect ratio flying wing.

Vertically offset horizontal stabilizers extending outside of airflow disturbed by the main wing section provide excellent stability for the low aspect ratio flying wing. They reduce “dutch roll” and “dihedral effect” instability. The low aspect ratio flying wing design with horizontal stabilizer laterally outboard of the lateral extents of the primary wing and significantly vertically displaced from the mean chord line of the primary wing provides improved aerodynamic efficiency, damping and stability throughout the flight envelope. The utility of these horizontal stabilizers is significantly more advantageous than predicted in application to flying wing designs of low aspect ratio actually improving efficiency and control. Abrupt fly-up and fly-down tendencies are reduced significantly over other tailed configurations.

Suction slots and rearward blowing slots on the low aspect ratio flying wing design with said tail assembly provide increased aerodynamic efficiency. Use of these techniques is novel because the short wingspan and potential to use of propulsion units of the flying wing to provide low and high pressure air reduce implementation complexity and weight. Thus, implementation is advantageous to improve aerodynamic efficiency. Thrust to weight ratio of state-of-the-art propulsion units provides excess thrust available for boundary layer control to increase lift of the flying wing. Application to low aspect ratio wings requires less ducting length and yields increased lift advantage. For a vehicle that is not thrust limited but is lift limited, such as the low aspect ratio flying wing, conversion of thrust to lift using suction and blowing boundary layer control is more advantageous and less complex than other approaches (i.e. thrust vectoring), non-obvious and novel.

In one calculated scenario use of boundary layer lift augmentation provides a 27% decrease in stall speed and produces additional lift force equivalent to 96% of design thrust. Thus, if thrust vectoring was used only 4% of thrust would be available for forward motion which would be insufficient to overcome drag at the calculated speed. The lift advantage from using excess thrust for boundary layer control is superior to thrust vectoring in the low aspect ratio wing. Thrust vectoring is very complex and costly for structure and dynamic control. For verification of this calculation be sure to consider the large surface area that will be used in the blowing slots coefficient of lift multiplier advantage despite low aspect ratio lift reductions as well as the additional angle of attack achievable because of leading edge suction and the relatively large diameter of the leading edge. Blowing and suction slots properly applied as in the present invention can practically and significantly offset the lower lift coefficients of low aspect ratio wings.

Suction slots and rearward blowing slots in low aspect ratio flying wing design provides other synergistic advantages such as roll, pitch and yaw control augmentation via asymmetric boundary layer manipulation. Localized lift modification on portions of the flying wing are used to provide roll, yaw and pitch changes. Providing differential air pressure to different areas of the wing using multiple slots or slots divided into lateral segments with a mechanism for air pressure control will change the aerodynamic forces on the wing. These forces can induce roll by increasing lift on one side of the wing while decreasing lift on the other. Using roll moment arm and multiple lateral segments, yaw can be induced on the wing by reducing drag on one side of the wing while maintaining net lift equal on both sides. Slots placed longitudinally at different locations on the wing, still running predominantly laterally across the top surface, vary pitch moment by changing air pressure generally forward or aft on the wing.

Lateral extension and retraction of the wing as disclosed in U.S. Pat. No. 2,294,367 (PTL 2) reduces profile drag, increases top speed and improves efficiency in multiple flight regimes such as cruise conditions. Present disclosures advance this “prior art” by making the vehicle itself aerodynamically stable and efficient. Thus the benefits of “prior art” are practically realizable through improvement of present disclosures.

### Advantageous Effects of Invention

Present disclosures reference a low aspect ratio flying wing that provides stability throughout the flight envelope from stall to maximum speed. This provides a stable low aspect ratio flying wing aircraft for all uses. A main structure of a low aspect ratio wing provides increased wing area yielding better than predicted advantage for improved lift generation using multiple design features. Unique tail configuration provides excellent stability at high and low angles of attack by minimizing effect of unpredictable aft end airflow characteristic of low aspect ratio wings. Further, this tail configuration provides significantly improved aerodynamic efficiency over other tail configurations. Novel use of suction and blowing slots on the present invention dramatically improves aerodynamic efficiency and coefficient of lift based on the large airfoil area and short wingspan with better than predicted results. Asymmetrically varying air pressure supplied to one or more suction and blowing slots provides aerodynamic optimization and control of yaw, pitch and roll independent of moveable surfaces. Application of suction and blowing slots specifically to wings of low aspect ratio is not found in “prior art” and is novel and non-obvious in that it provides better than predicted improvement in aerodynamic efficiency and control with lower implementation weight and structural complexity. Lateral extension and retraction of the wing improves aerodynamic efficiency and performance in multiple operational regimes. Combining these features creates a stable low aspect ratio flying wing at reduced cost and with improved aerodynamic efficiency providing better than predicted advantage. Furthermore, “prior art” professionals teach away from low aspect ratio aircraft applications particularly in flying wing designs failing to realize the better than predicted improvements of present disclosures.

Present disclosures fundamentally alter the performance and viability of the low aspect ratio flying wing. Combined in whole or in part the present invention provides synergistic advantage beyond that predicted by those skilled in the art. Combining these features advances the current low aspect ratio flying wing state of the art. Present invention is novel and non-obvious in part because a) a very crowded class has attempted but failed to make a practical implement for over 80 years b) none of the independent claims applied to low aspect ratio flying wings herein are noted in the “prior art” c) computational tools and tests cannot accurately predict the complex aft end flow of low aspect ratio wings (NPL 1) making tail configuration a critical design feature that is more complex than realized and not a simple “obvious to try” choice from multiple known options d) boundary layer control has better than predicted advantage in both aerodynamic efficiency and means of control when applied to low aspect ratio flying wing of present invention and e) those skilled in the art teach away from and discourage present invention aerodynamic shape, blowing and suction slots use and in general low aspect ratio wing design as inferior and impractical. This invention also drives against decades of broad popular opinion considering aircraft without long thin wings impractical.

### BRIEF DESCRIPTION OF DRAWINGS

Several example embodiments are selected for presentation from very numerous possible variations of a stable aerodynamically efficient low aspect ratio flying wing incorporating aspects of present disclosures. These embodiments do not represent comprehensive or inclusive coverage of all possible embodiments of disclosures in present claims. Embodiments are presented to aid in general understanding of applied art through a examples selected from very many possible representative systems as defined specifically in the claims.

FIG. 1 is a front perspective view of a flying wing representing embodiment example one;

FIG. 2 is a front plan view thereof;

FIG. 3 is a rear perspective view thereof;

FIG. 4 is a left side plan view thereof; right side is a mirror image;

FIG. 5 is a top plan view thereof; and

FIG. 6 is a bottom plan view thereof.

FIG. 7 is a front perspective view of a flying wing representing embodiment example two;

FIG. 8 is a front plan view thereof;

FIG. 9 is a rear perspective view thereof;

FIG. 10 is a left side plan view thereof; right side is a mirror image;

FIG. 11 is a top plan view thereof; and

FIG. 12 is a bottom plan view thereof.

FIG. 13 is a front perspective view of a flying wing representing embodiment example three;

FIG. 14 is a rear perspective view thereof;

FIG. 15 is a top plan view thereof.

FIG. 16 is a front perspective view of a flying wing representing embodiment example four;

FIG. 17 is a rear perspective view thereof;

FIG. 18 is a top plan view thereof.

FIG. 19 is a front perspective view of a flying wing representing embodiment example five with laterally retracted main structure wing and potential propulsion unit.

FIG. 20 is a front perspective view of a flying wing representing embodiment example six with laterally retracted main structure wing and retracted tails.

FIG. 21a, b is a left side plan view of a flying wing representing embodiment example seven illustrating a key aerodynamic efficiency advantage of present disclosure over prior art.

### DESCRIPTION OF EMBODIMENTS

### Detailed Description of the Invention

### EXAMPLES

Several embodiments within the scope of disclosures are illustrated to serve as examples for common reference to improve understanding of disclosures claimed. Examples include embodiments with and without dihedral and wing sweep as well as with and without boundary layer control in addition to with and without wings and tails retracted. A final additional illustration is useful in teaching discussions of an aerodynamic efficiency advantage of a vertically displaced horizontal stabilizer.

### Example 1

A first embodiment example is a low aspect ratio flying wing leveraging aspects of disclosures without dihedral, without wing sweep, and without boundary layer control.

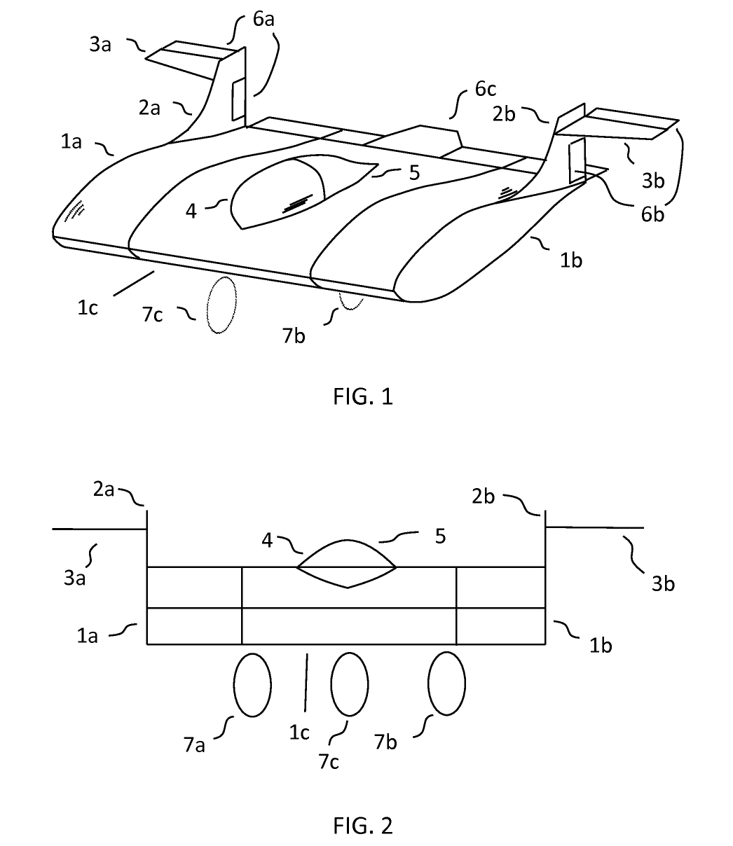

FIG. 1 is a front perspective of a first embodiment example illustrating portions of claimed disclosures. 1a, 1b, and 1c make up the main structure wing with 1a and 1b sections being laterally extendable and retractable to reduce or enlarge wing profile and surface area. 2a and 2b are possible vertical stabilizers. 3a and 3b are possible horizontal stabilizers configured outside of main structure wing turbulent boundary layer and vortices for improved control and efficiency. Item 4 illustrates one possible aerodynamic canopy configuration particularly useful for, but not limited to, manned versions of the vehicle. Item 5 illustrates one possible aerodynamic canopy fairing configuration to preserve aerodynamic efficiency of present canopies. 6a, 6b and 6c are possible configurations for moveable surfaces to control vehicle orientation by varying yaw (about vertical axis), roll (about longitudinal axis), and pitch (about the lateral axis) forces. 7c and 7b (7a blocked from view by main structure wing) represent possible ground wheel locations with required suspension omitted for clarity but implied in the design.

FIG. 2 is a front plan view of a first embodiment example illustrating portions of claimed disclosures. Item numbers are consistent with and described in FIG. 1. Control surfaces 6a, 6b, and 6c are present but not visible in this figure.

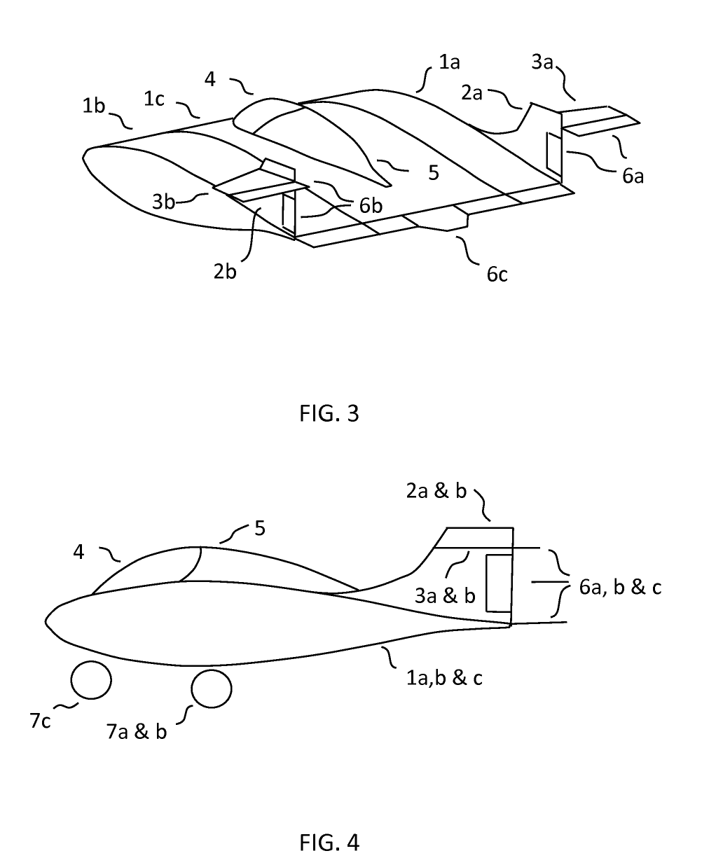

FIG. 3 is a rear perspective view of a first embodiment example illustrating portions of claimed disclosures. Item numbers are consistent with and described in FIG. 1. Ground wheels and implied suspension 7a, 7b, and 7c are present but not visible in this figure.

FIG. 4 is a left side plan view of a first embodiment example illustrating portions of claimed disclosures. Right side plan view is a mirror image of FIG. 4. Item numbers are consistent with and described in FIG. 1.

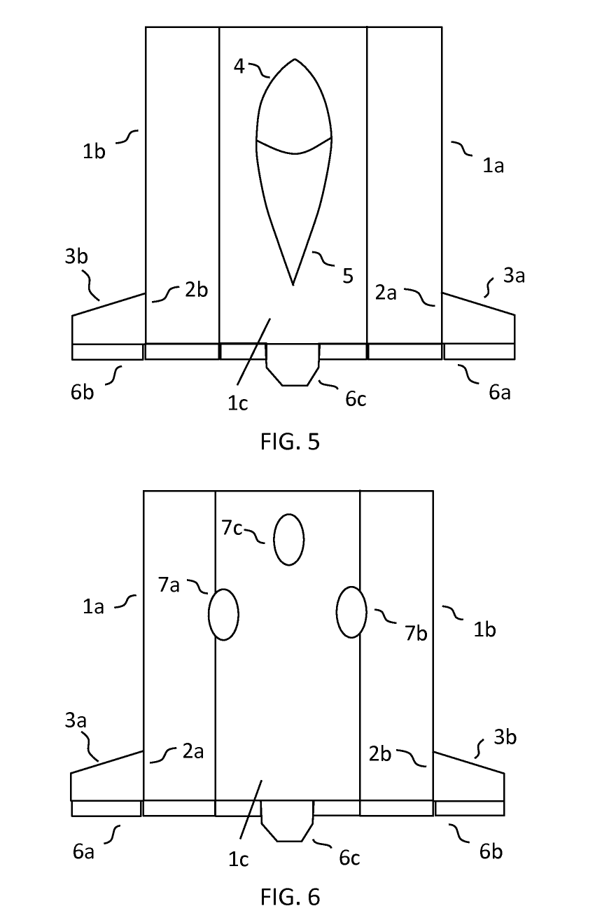

FIG. 5 is a top plan view of a first embodiment example illustrating portions of claimed disclosures. Item numbers are consistent with and described in FIG. 1. Ground wheels and implied suspension 7a, 7b, and 7c are present but not visible in this figure.

FIG. 6 is a front plan view of a first embodiment example illustrating portions of claimed disclosures. Item numbers are consistent with and described in FIG. 1. Aerodynamic canopy 4 and canopy fairing 5 are present but not visible in this figure.

### Example 2

A second embodiment example is a low aspect ratio flying wing leveraging aspects of disclosures with dihedral, with wing sweep, and without boundary layer control. Dihedral and wing sweep angles are selected from within the claimed disclosures to illustrate one possible variation.

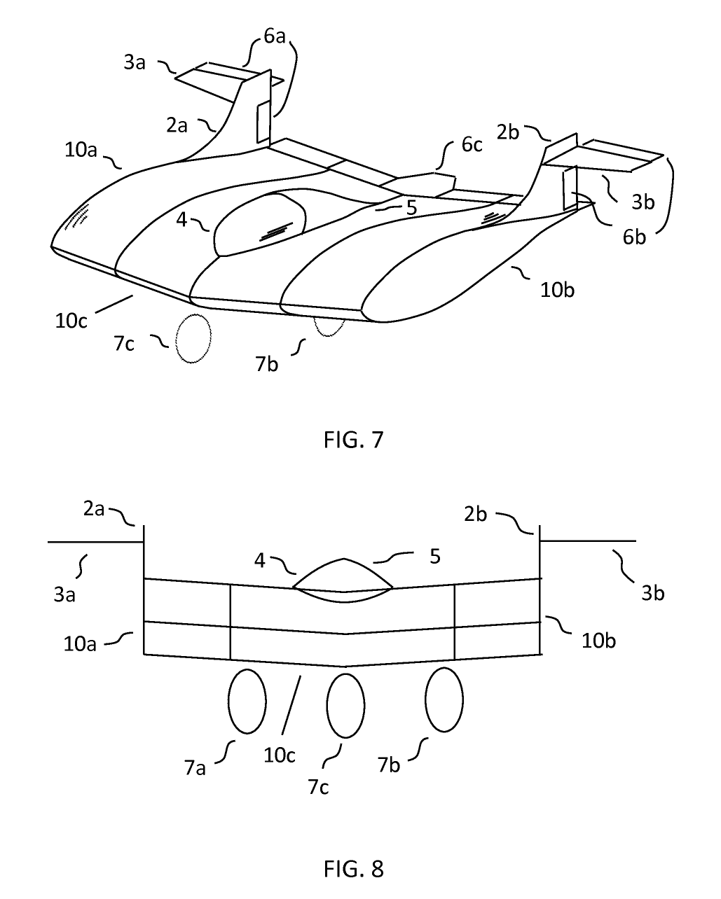

FIG. 7 is a front perspective of a second embodiment example illustrating portions of claimed disclosures. 10a, 10b, and 10c make up the main structure wing with 10a and 10b sections being laterally extendable and retractable to reduce or enlarge wing profile and surface area. 2a and 2b are possible vertical stabilizers. 3a and 3b are possible horizontal stabilizers configured for improved control and efficiency. Item 4 illustrates one possible aerodynamic canopy configuration particularly useful for, but not limited to, manned versions of the vehicle. Item 5 illustrates one possible aerodynamic canopy fairing configuration to preserve aerodynamic efficiency of present canopies. 6a, 6b and 6c are possible configurations for moveable surfaces to control vehicle orientation by varying yaw (about vertical axis), roll (about longitudinal axis), and pitch (about the lateral axis) forces. 7c and 7b (7a blocked from view by main structure wing) represent possible ground wheel locations with required suspension omitted for clarity but implied in the design.

FIG. 8 is a front plan view of a second embodiment example illustrating portions of claimed disclosures. Item numbers are consistent with and described in FIG. 7. Control surfaces 6a, 6b, and 6c are present but not visible in this figure.

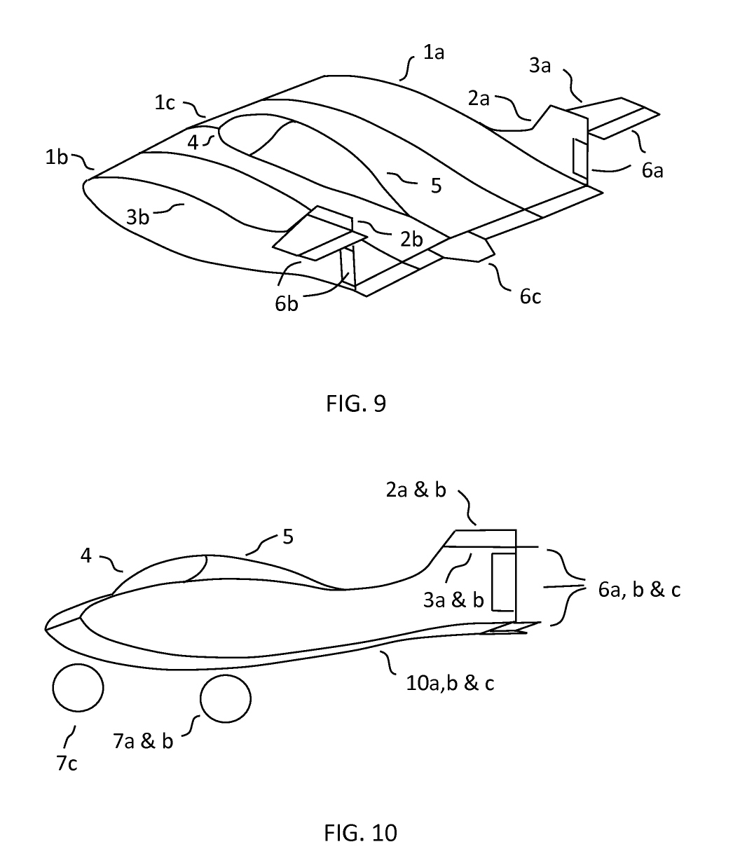

FIG. 9 is a rear perspective view of a second embodiment example illustrating portions of claimed disclosures. Item numbers are consistent with and described in FIG. 7. Ground wheels and implied suspension 7a, 7b, and 7c are present but not visible in this figure.

FIG. 10 is a left side plan view of a second embodiment example illustrating portions of claimed disclosures. Right side plan view is a mirror image of FIG. 7. Item numbers are consistent with and described in FIG. 1.

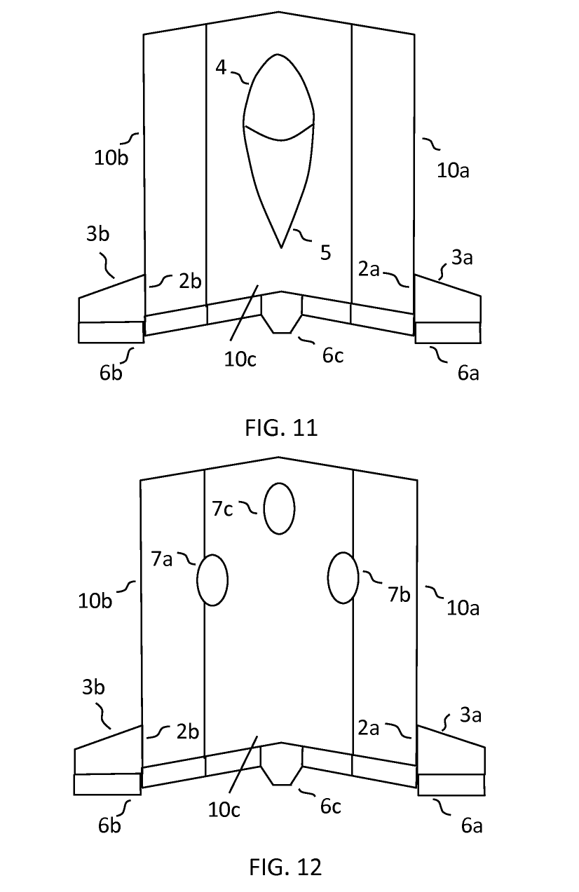

FIG. 11 is a top plan view of a second embodiment example illustrating portions of claimed disclosures. Item numbers are consistent with and described in FIG. 7. Ground wheels and implied suspension 7a, 7b, and 7c are present but not visible in this figure.

FIG. 12 is a bottom plan view of the second embodiment example illustrating portions of claimed disclosures. Item numbers are consistent with and described in FIG. 7. Aerodynamic canopy 4 and canopy fairing 5 are present but not visible in this figure.

### Example 3

A third embodiment example is a low aspect ratio flying wing leveraging aspects of disclosures without dihedral, without wing sweep, and with boundary layer control.

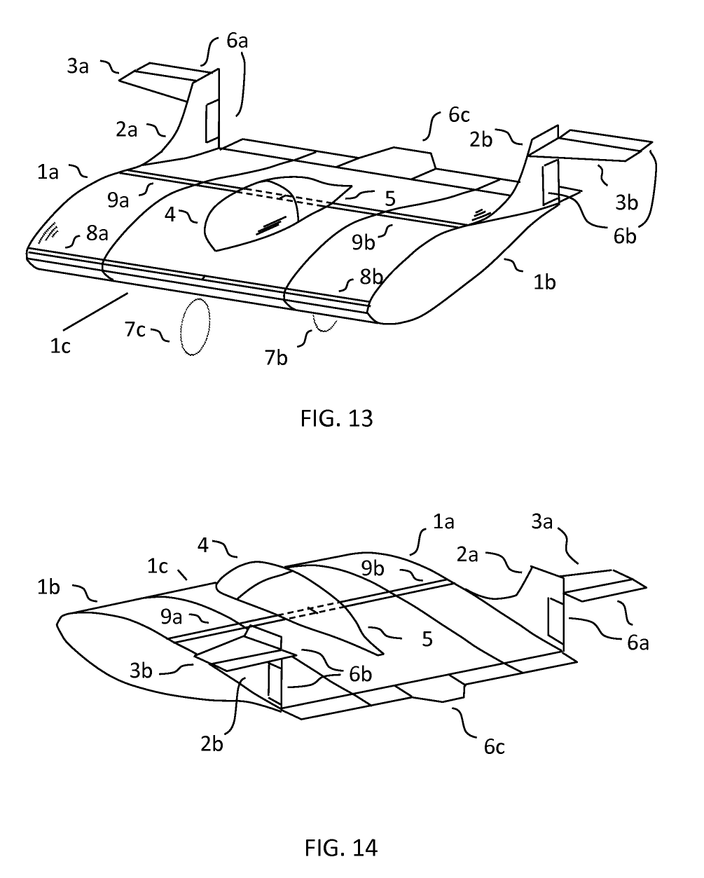

FIG. 13 is a front perspective of a third embodiment example illustrating portions of claimed disclosures. 1a, 1b, and 1c make up the main structure wing with 1a and 1b sections being laterally extendable and retractable to reduce or enlarge wing profile and surface area. 2a and 2b are possible vertical stabilizers. 3a and 3b are possible horizontal stabilizers structure wing turbulent boundary layer and vortices for improved control and efficiency. Item 4 illustrates one possible aerodynamic canopy configuration particularly useful for, but not limited to, manned versions of the vehicle. Item 5 illustrates one possible aerodynamic canopy fairing configuration to preserve aerodynamic efficiency of present canopies. 6a, 6b and 6c are possible configurations for moveable surfaces to control vehicle orientation by varying yaw (about vertical axis), roll (about longitudinal axis), and pitch (about the lateral axis) forces. 7c and 7b (7a blocked from view by main structure wing) represent possible ground wheel locations with required suspension omitted for clarity but implied in the design. 8a and 8b are possible locations complying with the disclosures claims for suction slots running laterally along the main structure wing just aft of the leading edge. 9a and 9b are possible locations complying with the disclosures claims for blowing slots running laterally along the main structure wing.

FIG. 14 is a rear perspective view of a third embodiment example illustrating portions of claimed disclosures. Item numbers are consistent with and described in FIG. 13. Ground wheels and implied suspension 7a, 7b, and 7c are present but not visible in this figure. 8a and 8b suctions slots are present but not visible in this figure.

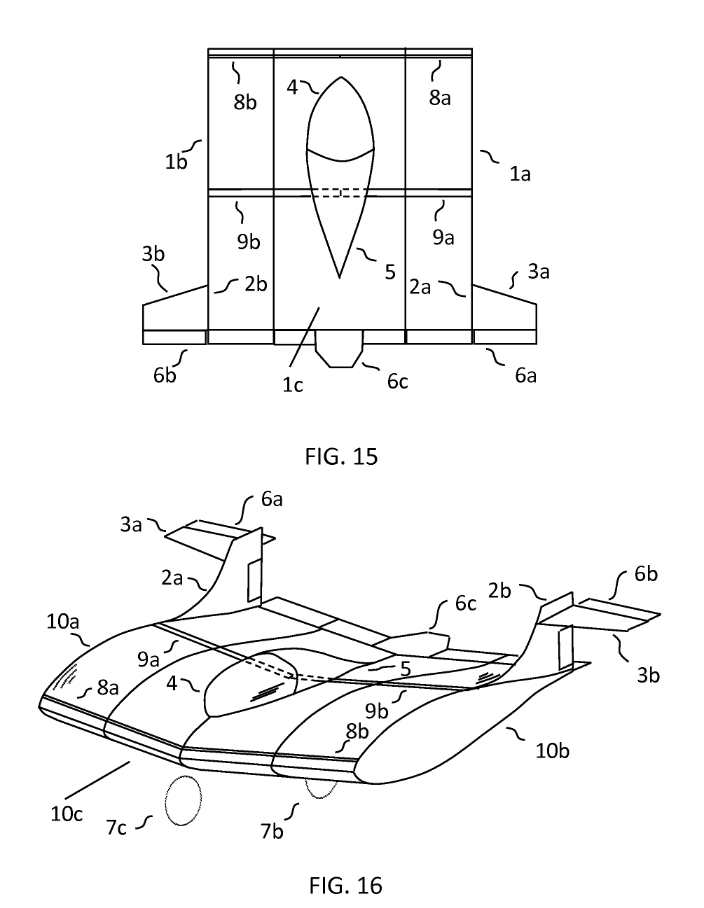

FIG. 15 is a top plan view of a third embodiment example illustrating portions of claimed disclosures. Item numbers are consistent with and described in FIG. 13. Ground wheels and implied suspension 7a, 7b, and 7c are present but not visible in this figure.

### Example 4

A fourth embodiment example is a low aspect ratio flying wing leveraging aspects of disclosures with dihedral, with wing sweep, and with boundary layer control.

FIG. 16 is a front perspective of a fourth embodiment example illustrating portions of claimed disclosures. 10a, 10b, and 10c make up the main structure wing with 10a and 10b sections being laterally extendable and retractable to reduce or enlarge wing profile and surface area. 2a and 2b are possible vertical stabilizers. 3a and 3b are possible horizontal stabilizers configured outside of main structure wing turbulent boundary layer and vortices for improved control and efficiency. Item 4 illustrates one possible aerodynamic canopy configuration particularly useful for, but not limited to, manned versions of the vehicle. Item 5 illustrates one possible aerodynamic canopy fairing configuration to preserve aerodynamic efficiency of present canopies. 6a, 6b and 6c are possible configurations for moveable surfaces to control vehicle orientation by varying yaw (about vertical axis), roll (about longitudinal axis), and pitch (about the lateral axis) forces. 7c and 7b (7a blocked from view by main structure wing) represent possible ground wheel locations with required suspension omitted for clarity but implied in the design. 8a and 8b are possible locations complying with the disclosures claims for suction slots running laterally along the main structure wing just aft of the leading edge. 9a and 9b are possible locations complying with the disclosures claims for blowing slots running laterally along the main structure wing.

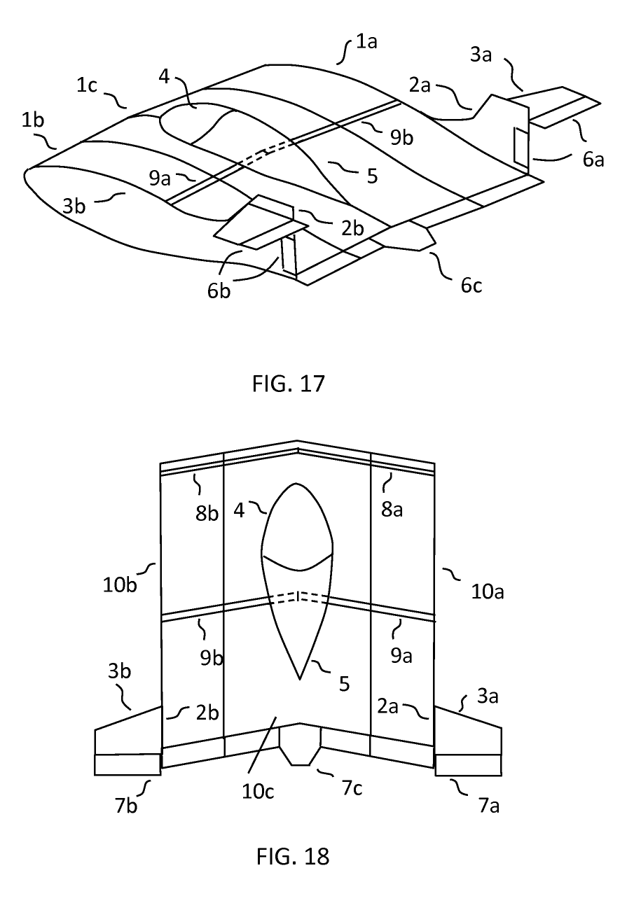

FIG. 17 is a rear perspective view of a fourth embodiment example illustrating portions of claimed disclosures. Item numbers are consistent with and described in FIG. 16. Ground wheels and implied suspension 7a, 7b, and 7c are present but not visible in this figure. 8a and 8b suctions slots are present but not visible in this figure.

FIG. 18 is a top plan view of a fourth embodiment example illustrating portions of claimed disclosures. Item numbers are consistent with and described in FIG. 16. Ground wheels and implied suspension 7a, 7b, and 7c are present but not visible in this figure.

### Example 5

A fifth embodiment example is a low aspect ratio flying wing with main structure wing retracted leveraging aspects of disclosures without dihedral, without wing sweep, and without boundary layer control.

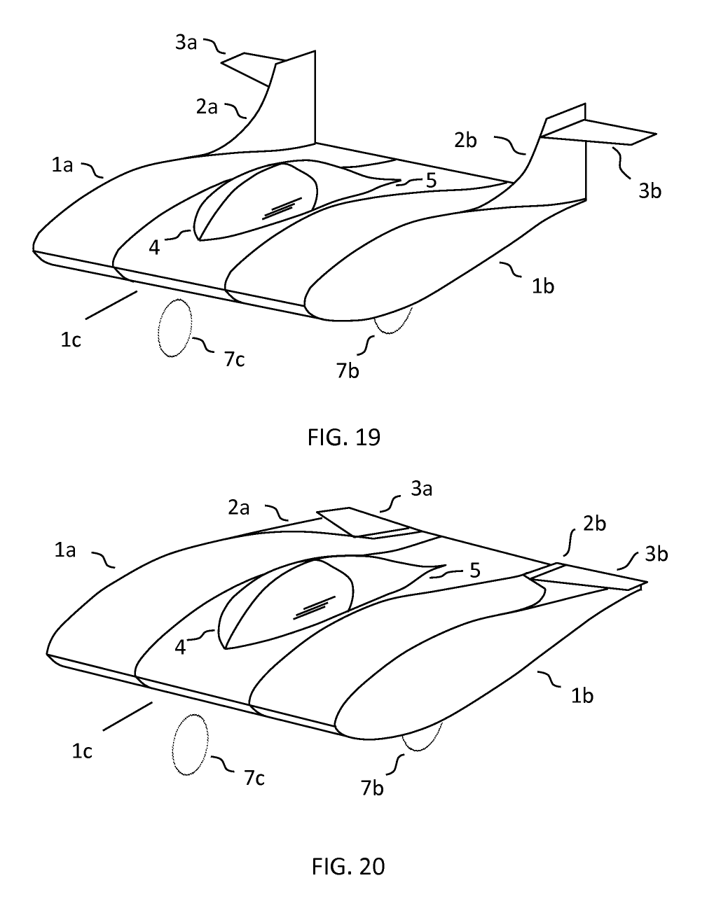

FIG. 19 is a front perspective view of a flying wing with main structure wing retracted in one of many embodiments possible within the scope of disclosures. 1a, 1b, and 1c make up the main structure wing with 1a and 1b sections being laterally extendable and retractable to reduce or enlarge wing profile and surface area. 1a and 1b are in this figure retracted laterally. 2a and 2b are possible vertical stabilizers. 3a and 3b are possible horizontal stabilizers configured outside of main structure wing turbulent boundary layer and vortices for improved control and efficiency. Item 4 illustrates one possible aerodynamic canopy configuration particularly useful for, but not limited to, manned versions of the vehicle. Item 5 illustrates one possible aerodynamic canopy fairing configuration to preserve aerodynamic efficiency of present canopies. 7c and 7b (7a blocked from view by main structure wing) represent possible ground wheel locations with required suspension omitted for clarity but implied in the design. Possible locations are shown for optional propulsion units 11a and 11b mounted on upper surface pylons.

Many types of propulsion units, configurations, mounting locations and methods are possible.

### Example 6

A sixth embodiment example is a low aspect ratio flying wing with main structure wing laterally retracted, tails retracted, leveraging aspects of disclosures without dihedral, without wing sweep, and without boundary layer control.

FIG. 20 is a front perspective view of a flying wing with main structure wing, vertical stabilizers and horizontal stabilizers retracted in one of many embodiments possible within the scope of disclosures. 1a, 1b, and 1c make up the main structure wing with 1a and 1b sections being laterally extendable and retractable to reduce or enlarge wing profile and surface area. 1a and 1b are in this figure retracted laterally. 2a and 2b are possible vertical stabilizers. 3a and 3b are possible horizontal stabilizers configured outside of main structure wing turbulent boundary layer and vortices for improved control and efficiency. 2a, 2b, 3a and 3b are retracted in this figure to show a possible retraction embodiment. Item 4 illustrates one possible aerodynamic canopy configuration particularly useful for, but not limited to, manned versions of the vehicle. Item 5 illustrates one possible aerodynamic canopy fairing configuration to preserve aerodynamic efficiency of present canopies. 7c and 7b (7a blocked from view by main structure wing) represent possible ground wheel locations with required suspension omitted for clarity but implied in the design.

### Example 7

A seventh embodiment illustration example is useful in understanding aerodynamic efficiency advantages of a vertically displaced horizontal stabilizer of present disclosures.

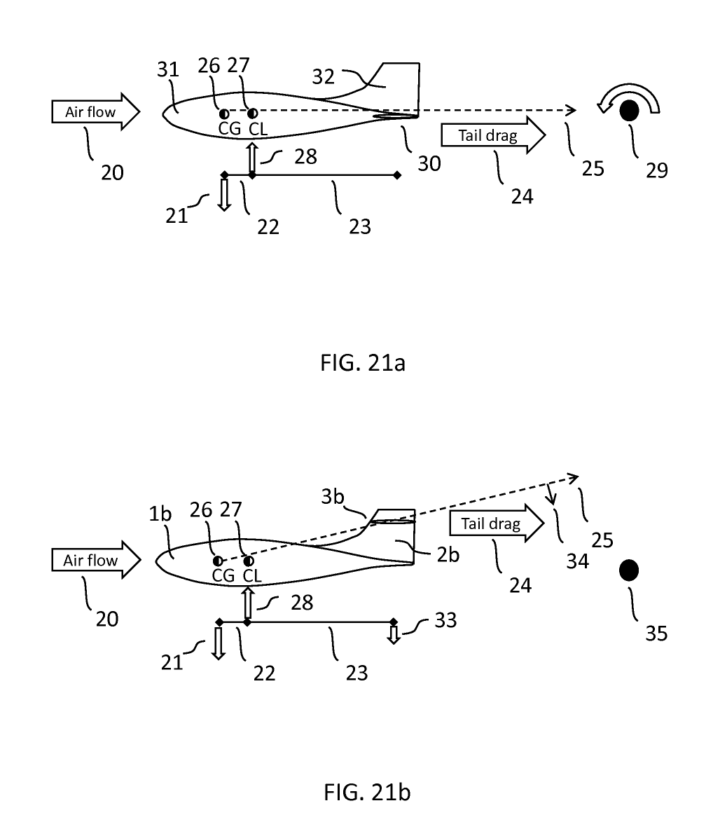

FIG. 21a is a side plan view of a “prior art” flying wing design wherein the horizontal stabilizer extends laterally past the extents of the main structure wing and is vertically near or on the main structure wing chord line. Airflow 20 passed longitudinally to the aft of the main structure wing 31. A vertical stabilizer 32 provides yaw (about the vertical axis) stabilization. Weight force of the vehicle 21 is shown at the center of gravity 26. Lift force of the main structure wing 28 is shown acting at the center of lift 27 with a lever arm 22 between the lift component 28 and the center of gravity 26. Location of the main structure wing lift force 28 behind the center of gravity 26 generates a forward pitching (about the lateral axis) moment 29. Horizontal stabilizer 30 is located along the main structure wing chord line that in “prior art” is parallel to the vector 25 extending from the center of gravity 26 through the horizontal stabilizer 30 to provide pitch (about the lateral axis) stabilization. Because of the vertical positioning of the horizontal stabilizer 30 on or near the chord line and in line with the center of gravity vector 25 the “tail drag” 24 resulting from airflow 20 over the horizontal stabilizer 30 generates no rearward pitching moment (about the lateral axis) to counteract the forward pitching moment 29. Horizontal stabilizer 30 would require increased negative angle of attack or increased downward lift unsymmetrical airfoil to generate the downward moment necessary to counteract the forward pitching moment 29 caused by the main structure wing lift pitching moment 28 about the center of gravity 26. Without increased negative angle of attack or increased downward lift unsymmetrical airfoil shape of horizontal stabilizer 30 typical of “prior art” designs the net pitching moment of the vehicle is forward. Increased negative angle of attack or downward lift airfoils employed on “prior art” horizontal stabilizers 30 increases profile and induced drag of the design. This increase in profile and induced drag reduces aerodynamic efficiency.

FIG. 21b is a side plan view representative of a possible embodiment of flying wing design disclosures wherein the horizontal stabilizer extends laterally past the extents of the main structure wing but is vertically offset from the wing chord line. Airflow 20 passes longitudinally to the aft of the main structure wing 1b. A vertical stabilizer 2b provides yaw (about the vertical axis) stabilization. Weight force of the vehicle 21 is shown at the center of gravity 26. Lift force of the main structure wing 28 is shown acting at the center of lift 27 with a lever arm 22 between the lift component 28 and the center of gravity 26. Location of the main structure wing lift force 28 behind the center of gravity 26 generates a forward pitching (about the lateral axis) moment 29. Horizontal stabilizer 3b is located along the main structure wing chord line 25 to provide pitch (about the lateral axis) stabilization. The vertical offset from the chord line of the horizontal stabilizer 30 caused the vector 25 from the center of gravity 26 to the horizontal stabilizer 30 to present at an angle with the “tail drag” 24 resulting from airflow 20 over the horizontal stabilizer 30. Since the vector 25 is not parallel with the “tail drag” 24 a rearward pitching moment (about the lateral axis) through the center of gravity 26 is generated counteracting the forward pitching moment 28 of the main structure wing lift yielding a more nearly net zero pitching moment 25. Because of this “tail drag” contribution counteracting the pitching moment the horizontal stabilizer 30 requires less negative angle of attack or downward lift unsymmetrical airfoil to counteract the forward pitching moment 29 caused by the main structure wing lift pitching moment 28 about the center of gravity 26. By requiring no or less negative angle of attack or downward lift unsymmetrical airfoil shape for horizontal stabilizer 30 than employed on “prior art”, horizontal stabilizer 30 profile and induced drag is reduced. This reduction in profile and induced drag increases aerodynamic efficiency. Increased angle of attack of main structure wing 1b (not shown) causes the “tail drag” 24 to be more closely aligned with the airflow 20 therefore reducing rearward pitching moment therefore naturally damping pitch disturbance for improved stability about the lateral axis.

### INDUSTRIAL APPLICABILITY

Disclosures herein can be directly applied to industrial, military and civil transportation vehicles, aviation, toys, radio control models, extreme high performance vehicle demonstrators and many other transportation, sporting and recreational industry applications. Application and depiction of these disclosures also extends to entertainment industries.

### REFERENCE SIGNS LIST

None applicable.

### REFERENCE TO DEPOSITED BIOLOGICAL MATERIAL

None applicable.

### SEQUENCE LISTING FREE TEXT

None applicable.

### SEQUENCE LISTING

None applicable.

Citation List
Patent Literature

| [PTL 1] U.S. Pat. No. 1,893,129 1893129 | January 1933 | Charpentier |
|---|---|---|
| [PTL 2] U.S. Pat. No. 2,294,367 2294367 | September 1942 | Fleming |
| [PTL 3] U.S. Pat. No. 2,402,358 2402358 | June 1946 | Bauman |
| [PTL 4] U.S. Pat. No. 2,561,291 2561291 | July 1951 | Rethorst |
| [PTL 5] U.S. Pat. No. 2,616,639 2616639 | November 1952 | Burnelli. |
| [PTL 6] U.S. Pat. No. 2,681,773 2681773 | June 1964 | Rethorst |
| [PTL 7] U.S. Pat. No. 2,734,701 2734701 | February 1956 | Horton |
| [PTL 7a] U.S. Pat. No. 2,877,965 2877965 | March 1959 | Wakefield |
| [PTL 8] U.S. Pat. No. 2,886,264 2886264 | May 1959 | Seager |
| [PTL 9] U.S. Pat. No. 2,989,269 2989269 | June 1961 | Le Bel |
| [PTL 9a] U.S. Pat. No. 3,026,066 3026066 | March 1962 | Coates |
| [PTL 10] U.S. Pat. No. 3,083,936 3083936 | April 1963 | Rethorst |
| [PTL 11] U.S. Pat. No. 3,536,278 3536278 | October 1970 | Walley |
| [PTL 12] U.S. Pat. No. 3,583,600 3583600 | June 1971 | Hurkamp et al |
| [PTL 13] U.S. Pat. No. D223,869 D223869 | June 1972 | Hurkamp |
| [PTL 14] U.S. Pat. No. 3,774,864 3774864 | November 1973 | Hurkamp |
| [PTL 14a] U.S. Pat. No. 3,869,102 3869102 | March 1975 | Carroll |
| [PTL 15] U.S. Pat. No. D396,685 D396685 | August 1978 | Baumgartner |
| | | et al |
| [PTL 16] U.S. Pat. No. 4,149,688 4149688 | April 1979 | Miller, Jr. |
| [PTL 17] U.S. Pat. No. 4,151,893 4151893 | May 1979 | Mantle |
| [PTL 18] U.S. Pat. No. 4,267,990 4267990 | May 1981 | Staudacher |
| [PTL 19] U.S. Pat. No. 4,440,361 4440361 | April 1984 | McGann |
| [PTL 20] U.S. Pat. No. 5,860,620 5860620 | January 1999 | Wainfan et al. |
| [PTL 21] U.S. Pat. No. 5,950,559 5950559 | September 1999 | Klem |
| [PTL 22] U.S. Pat. No. 6,098,922 6098922 | August 2000 | Hahl |
| [PTL 23] U.S. Pat. No. 6,325,011 6325011 | December 2001 | Klem |
| [PTL 24] U.S. Pat. No. 6,923,403 6923403 | August 2005 | Dizdarevic |
| | | et al. |
| [PTL 25] U.S. Pat. No. 7,059,259 7059259 | June 2006 | Allen |
| [PTL 26] U.S. Pat. No. 7,980,510 7980510 | July 2011 | Tanabe et al. |
| [PTL 27] U.S. Pat. No. 8,056,852 8056852 | November 2011 | Dizdarevic |
| | | et al. |
| [PTL 28] U.S. Pat. No. 8,262,031 8262031 | September 2012 | Zha et al. |
| [APP 01] US 2004/0050602 | March 2004 | Jones |
| [APP 02] US 2007/0018036 | January 2007 | Stephenson |
| [APP 03] US 2007/0018041 | January 2007 | Butler et al |
| [APP 04] WO/2008/054518 | 2008 | Zha et al. |

### Non Patent Literature

[NPL 1] DANIEL W. BANKS AND DAVID F. FISHER (2006). “Aft-End Flow of a Large-Scale Lifting Body During Free-Flight Tests”. NASA Dryden Flight Research Center. NASA/TM-2006-213681.
[NPL 2] R. DALE REED (1997). “Wingless Flight The Lifting Body Story”. NASA SP-4220. National Aeronautics and Space Administration, NASA History Office. Washington, D.C.
[NPL 3] KNIGHT, MONTGOMERY AND BAMBER, MILLARD J (1929). “Wind tunnel tests on airfoil boundary control using a backward opening slot”. NACA. 19930081087. 93R10377. NACA-TN-323. Apr. 7, 2011.
[NPL 4] ABBOT, IRA H. AND VON DOENHOFF, ALBERT E. (1949). “Theory of Wing Sections; Including a Summary of Airfoil Data”. Dover Publications, Inc. New York, N.Y. Pg 6-8.

While preferred embodiments of the present disclosures have been presented in detail, it should be understood by those skilled in the art that various other modifications may be made to the illustrated embodiments without departing from the scope of the disclosures herein as described in the specifications and defined in the appended claims.

I claim:

1. A flying wing comprising:
An aspect ratio greater than 0.5 and less than 1.5; and
A main structure of a wing, said main structure wing with a center of gravity located forward of 50 percent chord, said main structure wing aspect ratio greater than 0.5 and less than 1.5, said main structure wing is primary lifting airfoil; and
Horizontal stabilizers mirrored about a central plane, said central plane is defined by the longitudinal and vertical axis of the main structure wing, said horizontal stabilizers extending outboard of the lateral extents of the main structure wing by a distance greater than 10 percent of the main structure wing longest chord length, said horizontal stabilizers offset vertically from the main structure wing chord line by a distance greater than 10 percent of the main structure wing longest chord length, and said horizontal stabilizers positioned longitudinally aft of the main structure wing 50 percent chord point.

2. A flying wing of claim 1 further comprising:
The main structure wing is mirrored about the central plane defined by the main structure wing longitudinal and vertical axis, said main structure wing maximum thickness is greater than 10 percent of main structure wing longest chord length, said main structure wing shape is able to be defined by an extrusion of two-dimensional extrusion wing sections beginning with a two-dimensional wing section; and
Said extrusion extends outward from the longitudinal axis of the main structure wing, said extrusion remains within 45 degrees vertically of the lateral axis, said extrusion remains within 45 degrees longitudinally of the lateral axis, said extrusion has no more than 10 degrees of twist about the lateral axis from the two-dimensional wing section at any point along the extrusion; and
Said two-dimensional wing section is on the main structure wing longitudinal axis, said two-dimensional wing section is on the central plane defined by the main structure wing longitudinal and vertical axis; and
Said two-dimensional extrusion wing sections are on extrusion planes parallel to the central plane defined by the longitudinal axis and the vertical axis of the main structure wing at each point of the extrusion, said two-dimensional extrusion wing sections chord length is within 10 percent of the two-dimensional wing section chord length, said two-dimensional extrusion wing sections shape varies such that each two-dimensional extrusion wing section area is within 10 percent of the two-dimensional wing section area.

3. A flying wing of claim 1 comprising:
Vertical stabilizers mirrored about the central plane defined by the main structure wing longitudinal and vertical axis, said vertical stabilizers positioned laterally a distance less than 25 percent of the main structure wing longest chord length from the lateral extents of the main structure wing, and said vertical stabilizers positioned longitudinally aft of the main structure wing 50 percent chord point.

4. A flying wing of claim 3 wherein:
Said horizontal stabilizers extend laterally outboard from the vertical stabilizers.

5. A flying wing of claim 3 wherein:
Said vertical stabilizers moveably extend and retract.

6. A flying wing of claim 1 wherein:
Said horizontal stabilizers moveably extend and retract.

7. A flying wing of claim 1 comprising:
A propulsion unit located longitudinally between the main structure wing leading and trailing edges.

8. A flying wing of claim 1 comprising:
Said main structure wing that moveably extends and retracts laterally.

9. A flying wing of claim 1 comprising:
An aerodynamic canopy that protrudes from the main structure wing.

10. A flying wing of claim 1 comprising:
An aerodynamic canopy fairing that protrudes from the main structure wing.

11. A flying wing of claim 1 comprising:
A moveable control surface that alters aerodynamic forces to alter flying wing orientation.

12. A flying wing of claim 1 comprising:
Moveable wheels that support the flying wing while on the ground, said moveable wheels provide movement and control of flying wing while on the ground.

13. A flying wing comprising:
An aspect ratio greater than 0.5 and less than 1.5; and
A main structure of a wing, said main structure wing with a center of gravity located forward of 50 percent chord, said main structure wing aspect ratio greater than 0.5 and less than 1.5, said main structure wing is primary lifting airfoil; and
A suction slot located aft of the main structure wing leading edge by a distance less than 30 percent of the longest chord length, said suction slot extending laterally across a portion of the top surface of the main structure wing, said suction slot with an opening width less than 3 percent of the main structure wing longest chord length, said opening width measured at the smallest airflow opening on a two-dimensional cross section of the suction slot, said two-dimensional cross section cut along a plane parallel to the central plane defined by the longitudinal axis and the vertical axis.

14. A flying wing of claim 13 comprising:
An air pressure control that provides variable air pressure to said suction slot.

15. A flying wing of claim 14 comprising:
Said suction slot divided into lateral segments; and
Said air pressure control that provides independent variable air pressure delivery to each lateral segment.

16. A flying wing of claim 14 comprising:
Said suction slot divided into lateral segments, said lateral segments mirrored about the longitudinal axis of the main structure wing, said lateral segments located on either side laterally of the main structure wing longitudinal axis; and
Said air pressure control provides independent variable air pressure delivery to each lateral segment.

17. A flying wing comprising:
An aspect ratio greater than 0.5 and less than 1.5; and
A main structure of a wing, said main structure wing with a center of gravity located forward of 50 percent chord, said main structure wing aspect ratio greater than 0.5 and less than 1.5, said main structure wing is primary lifting airfoil; and
A blowing slot located longitudinally aft of the leading edge of the main structure wing by a distance greater than 30 percent of the longest chord length, said blowing slot extending laterally along a portion of the top surface of the main structure wing, said blowing slot with an opening width less than 3 percent of the main structure wing longest chord length, said opening width measured at the smallest airflow opening on a two-dimensional cross section of the blowing slot, said two-dimensional cross section cut along a plane parallel to the central plane defined by the longitudinal axis and the vertical axis.

18. A flying wing of claim 17 comprising:
An air pressure control that provides variable air pressure to said blowing slot.

19. A flying wing of claim 18 comprising:
Said blowing slot divided into lateral segments; and
Said air pressure control that provides independent variable air pressure delivery to each lateral segment.

20. A flying wing of claim 18 comprising:
Said blowing slot divided into lateral segments, said lateral segments mirrored about the longitudinal axis of the main structure wing, said lateral segments located on either side laterally of the main structure wing longitudinal axis; and
Said air pressure control that provides independent variable air pressure delivery to each lateral segment.
